(19) United States
(12) Patent Application Publication
(10) Pub. No.: US 2003/0007084 A1
(43) Pub. Date: Jan. 9, 2003

(54) Small image pickup module

(75) Inventor: Yasuo Nakjoh, Niiza-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/231,393

(22) Filed: Aug. 29, 2002

Related U.S. Application Data
(63) Continuation of application No. PCT/JP01/01226, filed on Feb. 21, 2001.

(30) Foreign Application Priority Data
Mar. 2, 2000 (JP) 2000-057282

(51) Int. Cl. H04N 5/225

(52) U.S. Cl. 348/340; 348/374

(57) ABSTRACT

A small image pickup module according to the present invention comprises a substrate, a semiconductor device chip for image pickup, a lens-barrel body, an infrared light blocking filter, a lens, and a diaphragm, in order to attempt to make assembly work easy and to reduce costs. The substrate is made from a nonmetal including a ceramic or the like. The semiconductor device chip for image pickup includes a two-dimensional C-MOS image sensor or the like which is mounted on the substrate. The lens-barrel body is adhered, as a reference to the substrate so as to cover the semiconductor device chip for image pickup, by using a potting material to be used for COB (Chip On Board) mounting as an adhesive. The infrared light blocking filter, lens, and diaphragm are respectively mounted on the lens-barrel body.

### CROSS-REFERENCE TO RELATED APPLICATIONS

This is a Continuation Application of PCT Application No. PCT/JP01/01226, filed Feb. 21, 2001, which was not published under PCT Article 21(2) in English.

This application is based upon and claims the benefit of priority from the prior Japanese Patent Application No. 2000-057282, filed Mar. 2, 2000, the entire contents of which are incorporated herein by reference.

### BACKGROUND OF THE INVENTION

1. Field of the Invention

The present invention relates to a small image pickup module, and in particular, to a small image pickup module in which a lens and a semiconductor device chip for image pickup are accommodated in one package and integrated.

2. Description of the Related Art

In recent years, the demand for small image sensor units has increased in fields of various types and various kinds of multimedia such as note-type personal computers, mobile phones and the like, and further, for image inputting equipment of information terminals such as monitoring cameras, video tape recorders and the like, and for in-vehicle applications and the like.

As a small image sensor unit suitable for this type of image inputting equipment, there is an image pickup module in which parts such as a solid-state image pickup device, a lens member, a filter, a diaphragm member and the like are accommodated in one package and integrated.

The image pickup module as a conventional image sensor unit has a structure in which, after a solid-state image pickup device is mounted on a substrate, the substrate is fixed in a package by screwing, adhesion or the like, and a supporting frame holding a lens member is mounted on the above-described package.

Since the image pickup module has a structure as described above, the accuracy of the positional relationship of the lens with respect to the solid-state image pickup device cannot be sufficiently ensured.

In this way, the accuracy of positioning of the lens with respect to the solid-state image pickup device is inferior in the image pickup module as a conventional image sensor unit. Therefore, a movable type focal point adjusting mechanism carrying out focusing is built into the package, each part is assembled in the package, and then focusing of the lens member with respect to the solid-state image pickup device is carried out by the focal point adjusting mechanism.

However, in accordance therewith, the work of focusing in which the movable type adjusting mechanism is operated after each part is assembled is necessary. Further, after the focus adjustment, the work of fixing a lens-barrel member or the like is necessary.

If the movable type focus adjusting mechanism is provided, there are trends that the structure becomes complicated, and the image pickup module as the image sensor unit becomes large.

Further, during the work of focusing, dust easily enters the unit from gaps of the movable portion of the focus adjusting mechanism, and a countermeasure therefor is necessary. For example, there is a need for the work of focus adjustment to be carried out in a clean room or the like, and productivity is inferior.

Moreover, if the movable focus adjusting mechanism receives vibration, shock or the like after completion of the product, there are drawbacks that the focusing position is easily distorted and the reliability of the product is inferior.

Accordingly, a solid-state image pickup apparatus structured such that the positioning accuracy, in the optical axis direction, of a lens with respect to a solid-state image pickup device can be easily ensured is proposed in Jpn. Pat. Appln. KOKAI Publication No. 9-232548.

The solid-state image pickup apparatus is configured such that a plurality of positioning portions are formed in step-shapes at a single supporting member, and parts such as a solid-state image pickup device, a lens member, a filter, a diaphragm member and the like are separately and individually attached to the individual positioning portions, thereby the respective members are positioned and fixed.

However, in such a solid-state image pickup apparatus, because the plurality of positioning portions are formed in step-shapes at the single supporting member, dimension errors between the respective steps directly and greatly affect the positioning accuracy of the respective members.

Moreover, in order to form the plurality of positioning portions in step-shapes at the single supporting member, management of the accuracy of the dimensions is difficult and errors occur easily. A high-level manufacturing technology is required to form the plurality of positioning portions in step-shapes at the one supporting member.

In particular, when the single supporting member is made from a ceramic, manufacture thereof is extremely difficult, and the product is expensive.

Here, it is mainly considered to manufacture the supporting member by injection molding by using synthetic resin or the like as the raw material.

However, even if the supporting member is made by injection molding, it is thought that it is easy for the dimensional errors between the respective positioning portions which are stepped to be large, and that the errors also increase due to changes over time thereafter, and reliability of the product is inferior.

Further, in Japanese Patent No. 2559986, a prior art is disclosed in which the substrate as described above is mounted by utilizing a spring effect using a side wall of an enclosure as a supporting member such as that described above.

However, in the prior art in accordance with Japanese Patent No. 2559986, there is a problem that joggling based on the creep phenomenon over time occurs.

Further, in Jpn. Pat. Appln. KOKOKU Publication No. 8-28435, a prior art relating to improvement of an adhesive structure of a metal can and a lens molten glass is disclosed. However, in the case of this structure, there is the need to consider the wetting characteristic of the molten glass.

Further, in Jpn. Pat. Appln. KOKAI Publication No. 10-41492, a prior art is disclosed in which a lens cap and a pedestal are positioned by a guide pin and fixed. However, in the case of this structure, there are the problems that the lens cap and the guide pin are necessary, the structure is complicated, productivity is poor, and the manufacturing costs increase.

Namely, in the conventional solid-state image pickup apparatus as described above, there were the problems that errors in the dimensions between the steps between the respective positioning portions occur easily, and it is difficult to manage the dimensions, and the positioning accuracy in the optical axis direction of the lens with respect to the solid-state image pickup device cannot be sufficiently ensured.

Further, in the conventional solid-state image pickup apparatus as described above, the structure is complicated, the productivity is poor, the manufacturing costs increase, and it is an expensive product.

### BRIEF SUMMARY OF THE INVENTION

An object of the present invention is to provide a small image pickup module which has been achieved in consideration of the circumstances, and in which, in a structure in which a semiconductor device chip for image pickup including a two-dimensional C-MOS image sensor or the like is mounted on a nonmetal substrate including a ceramic or the like and a lens-barrel body is mounted so as to cover the semiconductor device chip for image pickup, the assembly work is easy and a reduction in costs is possible due to the mounting structure being variously improved.

In order to achieve the above object, according to the present invention, there is provided,

(1) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter, a lens, and a diaphragm which are respectively mounted on the lens-barrel body,

wherein a potting material to be used for COB (Chip On Board) mounting is used as an adhesive adhering the lens-barrel body to the substrate.

In order to achieve the above object, according to the present invention, there is provided,

(2) a small image pickup module recited in item (1) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(3) a small image pickup module recited in item (1) above, wherein bare chips of various ICs are mounted on the substrate.

In order to achieve the above object, according to the present invention, there is provided,

(4) a small image pickup module recited in item (2) above, wherein bare chips of various ICs are mounted on the substrate.

In order to achieve the above object, according to the present invention, there is provided,

(5) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter, a lens, and a diaphragm which are respectively mounted on the lens-barrel body,

wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(6) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter, a lens, and a diaphragm which are respectively mounted on the lens-barrel body,

wherein bare chips of various ICs are mounted on the substrate.

In order to achieve the above object, according to the present invention, there is provided,

(7) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter, a lens, and a diaphragm which are respectively mounted on the lens-barrel body,

wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(8) a small image pickup module recited in item (7) above, wherein a potting material to be used for COB (Chip-On-Board) mounting is used as an adhesive adhering the lens-barrel body to the substrate.

In order to achieve the above object, according to the present invention, there is provided,

(9) a small image pickup module recited in item (7) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(10) a small image pickup module recited in item (7) above, wherein bare chips of various ICs are mounted on the substrate.

In order to achieve the above object, according to the present invention, there is provided,

(11) a small image pickup module recited in item (8) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(12) a small image pickup module recited in item (8) above, wherein bare chips of various ICs are mounted on the substrate.

In order to achieve the above object, according to the present invention, there is provided,

(13) a small image pickup module recited in item (9) above, wherein bare chips of various ICs are mounted on the substrate.

In order to achieve the above object, according to the present invention, there is provided,

(14) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter, a lens, and a diaphragm which are respectively mounted on the lens-barrel body,

wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(15) a small image pickup module recited in item (14) above, wherein a potting material to be used for COB (Chip-On-Board) mounting is used as an adhesive adhering the lens-barrel body to the substrate.

In order to achieve the above object, according to the present invention, there is provided,

(16) a small image pickup module recited in item (14) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(17) a small image pickup module recited in item (15) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(18) a small image pickup module recited in item (14) above, wherein bare chips of various ICs are mounted on the substrate.

In order to achieve the above object, according to the present invention, there is provided,

(19) a small image pickup module recited in item (15) above, wherein bare chips of various ICs are mounted on the substrate.

In order to achieve the above object, according to the present invention, there is provided,

(20) a small image pickup module recited in item (16) above, wherein bare chips of various ICs are mounted on the substrate.

In order to achieve the above object, according to the present invention, there is provided,

(21) a small image pickup module recited in item (14) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(22) a small image pickup module recited in item (15) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(23) a small image pickup module recited in item (16) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(24) a small image pickup module recited in item (18) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(25) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached as a reference to the substrate so as to cover the semiconductor device chip for image pickup; and

an infrared light blocking filter which is mounted on the lens-barrel body,

wherein the lens-barrel body has a structure such that another lens-unit can be mounted.

In order to achieve the above object, according to the present invention, there is provided,

(26) a small image pickup module recited in item (25), wherein a potting material to be used for COB (Chip-On-Board) mounting is used as an adhesive adhering the lens-barrel body to the substrate.

In order to achieve the above object, according to the present invention, there is provided,

(27) a small image pickup module recited in item (26) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(28) a small image pickup module recited in item (26) above, wherein bare chips of various ICs are mounted on the substrate.

In order to achieve the above object, according to the present invention, there is provided,

(29) a small image pickup module recited in item (26) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(30) a small image pickup module recited in item (26) above, wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(31) a small image pickup module recited in item (27) above, wherein bare chips of various ICs are mounted on the substrate.

In order to achieve the above object, according to the present invention, there is provided,

(32) a small image pickup module recited in item (25) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(33) a small image pickup module recited in item (32) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(34) a small image pickup module recited in item (32) above, wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(35) a small image pickup module recited in item (25) above, wherein bare chips of various ICs are mounted on the substrate.

In order to achieve the above object, according to the present invention, there is provided,

(36) a small image pickup module recited in item (35) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(37) a small image pickup module recited in item (35) above, wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(38) a small image pickup module recited in item (25) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(39) a small image pickup module recited in item (38) above, wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(40) a small image pickup module recited in item (25) above, wherein a land-and-through-hole portion for external connection is provided at the substrate, and electric connection and mechanical holding with another substrate are made possible due to the other substrate being engaged at the land-and-through-hole portion.

In order to achieve the above object, according to the present invention, there is provided,

(41) a small image pickup module recited in any one of items (1) to (40) above, wherein a through-hole portion is provided in order to electrically connect between the wiring patterns of a plurality of layers or surfaces of the substrate which exist at a region of the substrate covered at least by the lens-barrel body, and the through-hole portion is light-blocked by being filled with a solder.

### BRIEF DESCRIPTION OF THE SEVERAL VIEWS OF THE DRAWING

FIG. 1 is a cross-sectional view showing a basic structure of a small image pickup module according to the present invention.

FIG. 2 is a cross-sectional view showing a schematic structure of a small image pickup module according to a first embodiment of the present invention.

FIG. 3 is a cross-sectional view showing a schematic structure of a small image pickup module according to a second embodiment of the present invention.

FIG. 4 is a cross-sectional view showing a schematic structure of a small image pickup module according to a third embodiment of the present invention.

FIG. 5A and FIG. 5B are a cross-sectional view and a rear view showing a schematic structure of a small image pickup module according to a fourth embodiment of the present invention.

FIG. 6 is a cross-sectional view showing a schematic structure of a small image pickup module according to a fifth embodiment of the present invention.

FIG. 7 is a cross-sectional view showing a schematic structure of a small image pickup module according to a sixth embodiment of the present invention.

FIG. 8 is a cross-sectional view showing a schematic structure of a small image pickup module according to a seventh embodiment of the present invention.

FIG. 9 is a cross-sectional view showing a schematic structure of a small image pickup module according to an eighth embodiment of the present invention.

FIG. 10 is a cross-sectional view showing a schematic structure of a small image pickup module according to a ninth embodiment of the present invention.

FIG. 11A and FIG. 11B are a cross-sectional view and a rear view showing a schematic structure of a small image pickup module according to a tenth embodiment of the present invention.

FIG. 12 is a cross-sectional view showing a schematic structure of a small image pickup module according to an eleventh embodiment of the present invention.

FIG. 13 is a cross-sectional view showing a schematic structure of a small image pickup module according to a twelfth embodiment of the present invention.

### DETAILED DESCRIPTION OF THE INVENTION

Hereinafter, respective embodiments of the present invention will be described by using the figures.

(Basic Structure)

FIG. 1 is a cross-sectional view showing a basic structure as a small image pickup module according to the present invention.

Namely, as shown in FIG. 1, the small image pickup module according to the present invention is, as the basic structure, structured from a rectangular-shaped substrate 11 made from a nonmetal including a ceramic or the like, a semiconductor device chip 12 for image pickup including a two-dimensional C-MOS image sensor or the like which is mounted on the nonmetal substrate 11, a lens-barrel body 13 which has a hollow structure such as a rectangular cylinder shape or the like and which is attached as a reference to the nonmetal substrate 11 so as to cover the semiconductor device chip 12 for image pickup, and an infrared light (IR) blocking filter 14, a lens 15, and a diaphragm 16 which are respectively mounted on the lens-barrel body 13.

Here, it is assumed that, there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an analog-to-digital converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the nonmetal substrate 11 made from ceramic is a plate-shaped structure having a rectangular shape and a uniform thickness in which a raw material of an integral bulk material is calcinated, and the top surface thereof is formed so as to uniformly be the same flat surface.

The small image pickup module thus structured according to the basic structure of the present invention operates such that, for example, a digital or analog image signal is output by image-forming a photographed object image on the sensor section at the semiconductor device chip 12 for image pickup on the nonmetal substrate 11 via the diaphragm section 16, the lens 15, and the infrared light (IR) blocking filter 14, and by photoelectrically converting the image.

Further, in the small image pickup module according to the basic structure of the present invention structured as described above, a package in which a two-dimensional sensor according to the prior art is independently housed can be omitted. A reduction in cost and an improvement of mounting performance can be attempted while improving the optical performance.

(First Embodiment)

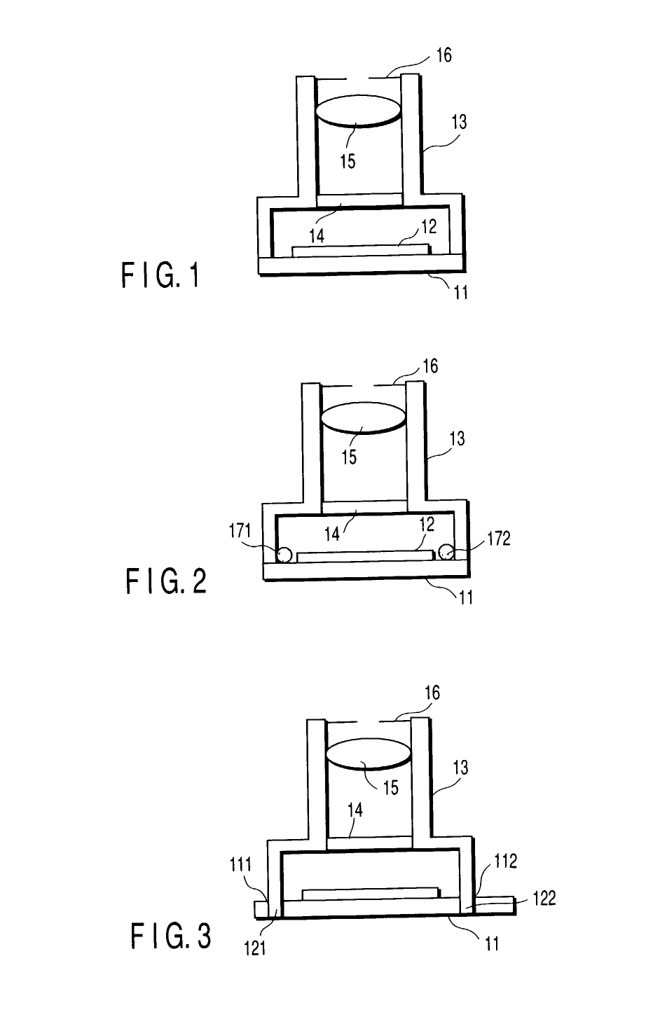

FIG. 2 is a cross-sectional view showing a schematic structure of a small image pickup module according to a first embodiment of the present invention.

Namely, as shown in FIG. 2, the small image pickup module according to the first embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the first embodiment of the present invention is characterized by using potting materials 171, 172 to be used for COB (Chip on Board) mounting as an adhesive adhering the lens-barrel body to the nonmetal substrate 11.

Further, in the basic structure, the small image pickup module according to the first embodiment of the present invention structured as described above has a feature that a package in which a two-dimensional sensor according to a prior art is independently housed can be omitted, and a reduction in cost and an improvement of mounting performance can be attempted while improving the optical performance. In addition, the small image pickup module has the following features.

Namely, because a material different from the potting material used for Chip On Board (COB) mounting is used for adhesion of the lens-barrel body at the two-dimensional sensor according to the prior art, there are problems such as the generation of rust or the like with respect to the sensor at the interior, and problems in durability and assembly working performance remain. However, in the small image pickup module according to the first embodiment of the present invention, because the potting materials 171, 172 to be used for Chip-On-Board (COB) mounting are used as the adhesive adhering the lens-barrel body 13 to the nonmetal substrate 11, there is no problem such as the generation of rust or the like with respect to the sensor at the interior. It is possible to contribute to an improvement in durability and assembly working performance.

In this case, the potting materials 171, 172 have the function of being commonly used as filler and adhesive.

(Second Embodiment)

FIG. 3 is a cross-sectional view showing a schematic structure of a small image pickup module according to a second embodiment of the present invention.

Namely, as shown in FIG. 3, the small image pickup module according to the second embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the second embodiment of the present invention is characterized in that, as a mounting structure which mounts the lens-barrel body 13 on the nonmetal substrate 11, projections 121, 122 for positioning are provided at the bottom portion of the lens-barrel body 13, and fitting holes 111, 112, in which the projections 121, 122 for positioning provided at the bottom portion of the lens-barrel body are fitted, are provided at opposing positions on the nonmetal substrate 11.

Further, in the basic structure, the small image pickup module according to the second embodiment of the present invention structured as described above has a feature that a package in which a two-dimensional sensor according to the prior art is independently housed can be omitted, and a reduction in cost and an improvement of mounting performance can be attempted while improving the optical performance. In addition, the small image pickup module has the following features.

Namely, the holes for positioning of the lens-barrel body in the two-dimensional sensor in accordance with the prior art are such that the holes are not simply open at the substrate, but the shape of the substrate is formed in three dimensions to always match the lens-barrel body. Therefore, this is a cause for the costs to remarkably increase. However, in the small image pickup module according to the second embodiment of the present invention, because the nonmetal substrate 11 is plate-shaped as is, it is extremely inexpensive and assembly also is easy.

(Third Embodiment)

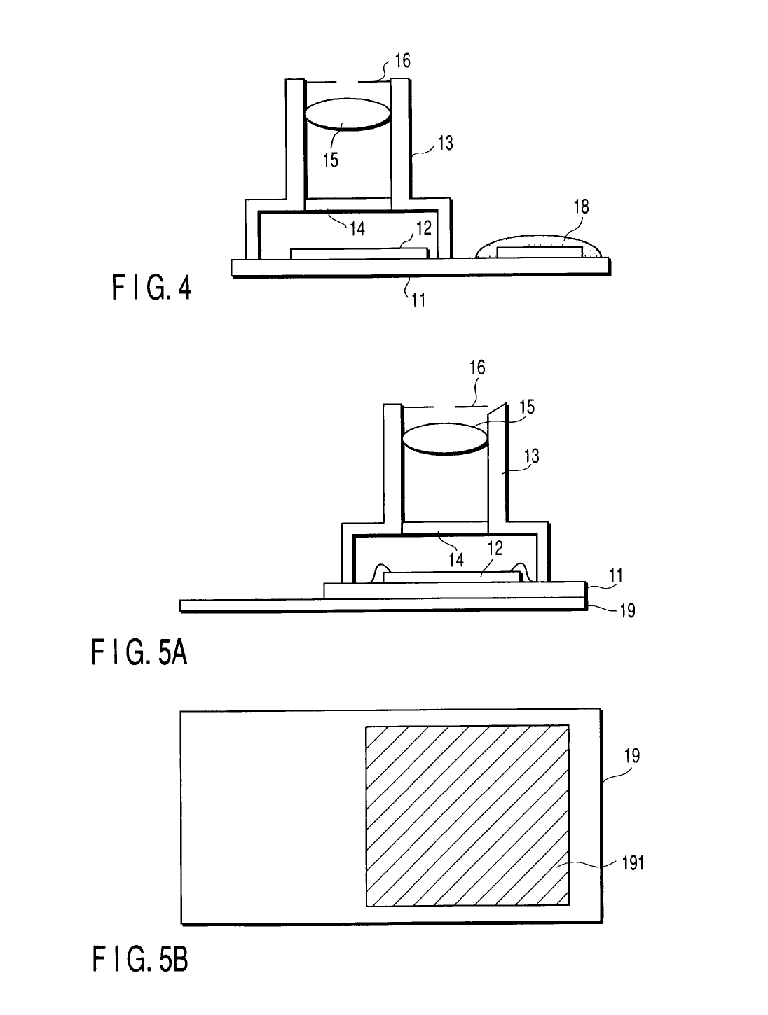

FIG. 4 is a cross-sectional view showing a schematic structure of a small image pickup module according to a third embodiment of the present invention.

Namely, as shown in FIG. 4, the small image pickup module according to the third embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the third embodiment of the present invention is characterized in that bare chips 18 of various ICs are mounted at the outside portion of the lens-barrel body 13 on the nonmetal substrate 11.

Further, in the basic structure, the small image pickup module according to the third embodiment of the present invention structured as described above has a feature that a package in which a two-dimensional sensor according to the prior art is independently housed can be omitted, and a reduction in cost and an improvement of mounting performance can be attempted while improving the optical performance. In addition, the small image pickup module has the following features.

Namely, in the two-dimensional sensor in is accordance with the prior art, the substrate for mounting a sensor and other bare chips are not integrally structured, but are always structured so as to be separated into two or more substrates. Therefore, cables and connectors for connecting between the respective substrates are needed. Thus, this is a hindrance to prevention of noise generation and reduction in costs. However, in the small image pickup module according to the third embodiment of the present invention, by mounting the bare chips 18 of various ICs at the outside portion or the like of the lens-barrel body 13 on the nonmetal substrate 11, all of the deficiencies in accordance with the prior art can be solved.

(Fourth Embodiment)

FIG. 5A and FIG. 5B are a cross-sectional view and a rear view showing a schematic structure of a small image pickup module according to a fourth embodiment of the present invention.

Namely, as shown in FIG. 5A and FIG. 5B, the small image pickup module according to the fourth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the fourth embodiment of the present invention is characterized in that a flexible substrate 19 for external connection is mounted on the nonmetal substrate 11, and a light-blocking pattern 191, formed by adhesion of a conductive material (etching) or silkscreen printing or the like, is formed on the flexible substrate 19 in order to block the light from the direction of the bottom portion of the nonmetal substrate 11.

Further, in the basic structure, the small image pickup module according to the fourth embodiment of the present invention structured as described above has a feature that a package in which a two-dimensional sensor according to the prior art is independently housed can be omitted, and a reduction in cost and an improvement of mounting performance can be attempted while improving the optical performance. In addition, the small image pickup module has the following features.

Namely, in the two-dimensional sensor in accordance with the prior art, the substrate for mounting a sensor must be a material which is expensive and has a light-blocking ability in order to provide the substrate itself with a light-blocking ability. However, in the small image pickup module according to the fourth embodiment of the present invention, as the material of the nonmetal substrate 11, even a flexible substrate having no light-blocking ability in particular can be used as is, and it can be inexpensive.

(Fifth Embodiment)

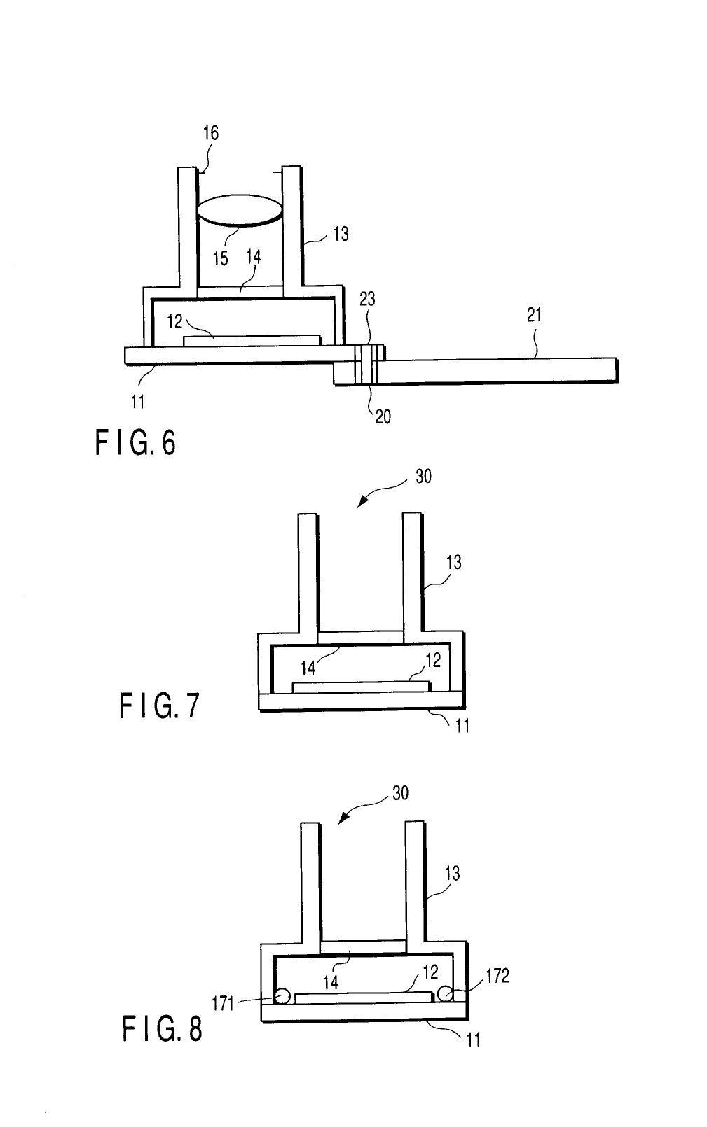

FIG. 6 is a cross-sectional view showing a schematic structure of a small image pickup module according to a fifth embodiment of the present invention.

Namely, as shown in FIG. 6, the small image pickup module according to the fifth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the fifth embodiment of the present invention is characterized in that a land-and-through-hole portion 20 for external connection is provided at the nonmetal substrate 11, and electric connection and mechanical holding of the nonmetal substrate 11 and another substrate 21 are made possible due to the other substrate 21 being soldered or engaged by a metal pin 23 at the land-and-through-hole portion 20.

Further, in the basic structure, the small image pickup module according to the fifth embodiment of the present invention structured as described above has a feature that a package in which a two-dimensional sensor according to the prior art is independently housed can be omitted, and a reduction in cost and an improvement of mounting performance can be attempted while improving the optical performance. In addition, the small image pickup module has the following features.

Namely, in the two-dimensional sensor in accordance with the prior art, as means for transmitting signals from the substrate for mounting a sensor to another substrate, connecting by cables, connectors, the flexible substrate and the like, is carried out via a third transmitting material with respect to another substrate. Therefore, this is a hindrance to prevention of noise generation and a reduction in costs. However, in the small image pickup module according to the fifth embodiment of the present invention, it is possible to directly connect the nonmetal substrate 11 for mounting a sensor and the other substrate 21 at the through-hole portion 20. Thus, it is possible to reduce size, reduce costs, and prevent noise generation.

(Sixth Embodiment)

FIG. 7 is a cross-sectional view showing a schematic structure of a small image pickup module according to a sixth embodiment of the present invention.

Namely, as shown in FIG. 7, the small image pickup module according to the sixth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the sixth embodiment of the present invention is characterized in that the lens 15 and the diaphragm 16 are not directly mounted on the lens-barrel body 13 as in the basic structure shown in FIG. 1, but the lens-barrel mounting portion 30, structured such that another lens-unit can be mounted on the top portion of the lens-barrel body 13, is provided.

Further, in the basic structure, the small image pickup module according to the sixth embodiment of the present invention structured as described above has a feature that a package in which a two-dimensional sensor according to the prior art is independently housed can be omitted, and a reduction in cost and an improvement of mounting performance can be attempted while improving the optical performance. In addition, the lens-barrel mounting portion 30 is provided at the top portion of the lens-barrel body 13, thereby another lens-unit can be mounted at the top portion of the lens-barrel body 13.

(Seventh Embodiment)

FIG. 8 is a cross-sectional view showing a schematic structure of a small image pickup module according to a seventh embodiment of the present invention.

Namely, as shown in FIG. 8, the small image pickup module according to the seventh embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the seventh embodiment of the present invention is characterized in that the lens 15 and the diaphragm 16 are not directly mounted on the lens-barrel body 13 as in the basic structure shown in FIG. 1, but the lens-barrel mounting portion 30, structured such that another lens-unit can be mounted on the top portion of the lens-barrel body 13, is provided, and that the potting materials 171, 172 to be used for COB (Chip-On-Board) mounting are used as an adhesive adhering the lens-barrel body 13 to the nonmetal substrate 11.

Further, in the basic structure, the small image pickup module according to the seventh embodiment of the present invention structured as described above has a feature that a package in which a two-dimensional sensor according to a prior art is independently housed can be omitted, and a reduction in cost and an improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, since the potting materials 171, 172 to be used for COB (Chip-On-Board) mounting are used as an adhesive adhering the lens-barrel body 13 to the nonmetal substrate 11, there is no problem such as the generation of rust or the like with respect to the sensor at the interior, thereby it is possible to contribute to an improvement in durability and assembly working performance.

(Eighth Embodiment)

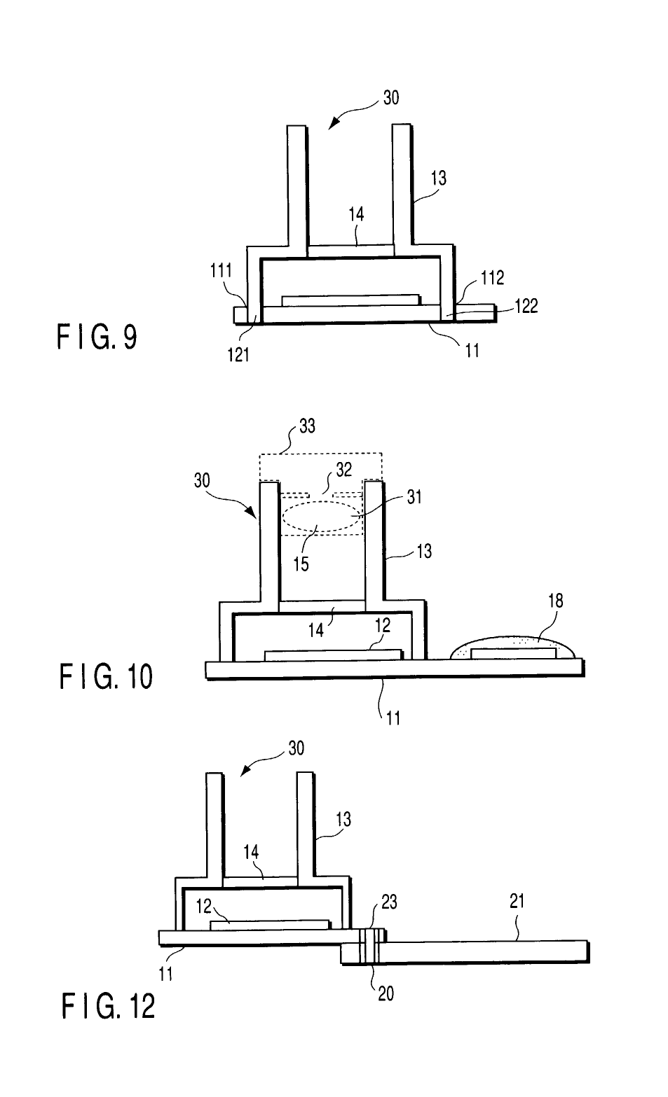

FIG. 9 is a cross-sectional view showing a schematic structure of a small image pickup module according to an eighth embodiment of the present invention.

Namely, as shown in FIG. 9, the small image pickup module according to the eighth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the eighth embodiment of the present invention is characterized in that the lens 15 and the diaphragm 16 are not directly mounted on the lens-barrel body 13 as in the basic structure shown in FIG. 1, but the lens-barrel mounting portion 30, structured such that another lens-unit can be mounted on the top portion of the lens-barrel body 13, is provided. The small image pickup module is also characterized in that, as the structure for attaching the lens-barrel body 13 to the nonmetal substrate 11, the projection 121 for positioning is provided at the bottom portion of the lens-barrel body 13 and the fitting holes 111, 112, in which the projection 121 for positioning provided at the bottom portion of the lens-barrel body 13 is fitted, are provided at opposing positions on the nonmetal substrate 11.

Further, in the basic structure, the small image pickup module according to the eighth embodiment of the present invention structured as described above has a feature that a package in which a two-dimensional sensor according to a prior art is independently housed can be omitted, and a reduction in cost and an improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, as the attaching structure for attaching the lens-barrel body 13 to the nonmetal substrate 11, the projections 121, 122 for positioning are provided at the bottom portion of the lens-barrel body 12 and the fitting holes 111, 112, in which the projections 121, 122 for positioning provided at the bottom portion of the lens-barrel body 13 are fitted, are provided at opposing positions on the nonmetal substrate 11. Thus, it suffices for the nonmetal substrate 11 to have a planar configuration as is, thereby it is possible to be extremely inexpensive and to be easily assembled.

(Ninth Embodiment)

FIG. 10 is a cross-sectional view showing a schematic structure of a small image pickup module according to a ninth embodiment of the present invention.

Namely, as shown in FIG. 10, the small image pickup module according to the ninth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the ninth embodiment of the present invention is characterized in that the lens 15 and the diaphragm 16 are not directly mounted on the lens-barrel body 13 as in the basic structure shown in FIG. 1, but the lens-barrel mounting portion 30, structured such that another lens-unit can be mounted on the top portion of the lens-barrel body 13, is provided, and bare chips 18 of the respective ICs are mounted.

Further, in the basic structure, the small image pickup module according to the ninth embodiment of the present invention structured as described above has a feature that a package in which a two-dimensional sensor according to the prior art is independently housed can be omitted, and a reduction in cost and an improvement of mounting performance can be attempted while improving the optical performance. In addition, the lens-barrel mounting portion 30 is provided at the top portion of the lens-barrel body 13, thereby another lens-unit 33 in which a lens 31 and a diaphragm 32 are built-in in advance, can be mounted on the top portion of the lens-barrel body 13. Further, since the bare chips 18 of the respective ICs are mounted on the outside portion or the like of the lens-barrel body 13 on the nonmetal substrate 11, it is possible to solve all of the deficiencies such as hindering prevention of noise generation and a reduction in costs or the like.

(Tenth Embodiment)

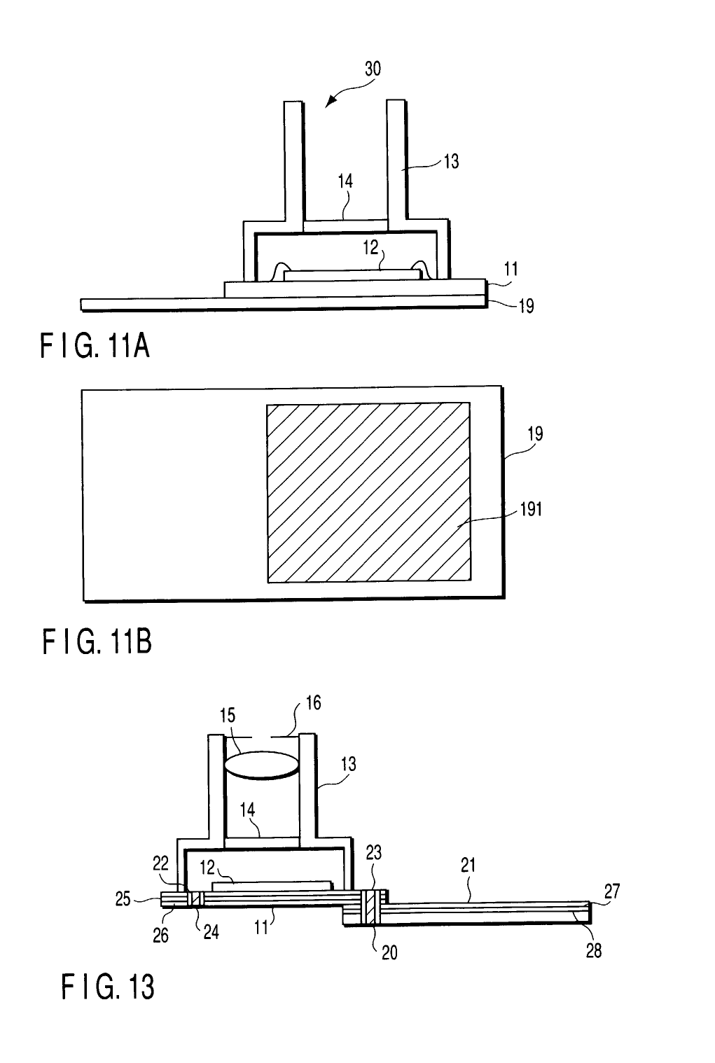

FIG. 11A and FIG. 11B are a cross-sectional view and a rear view showing a schematic structure of a small image pickup module according to a tenth embodiment of the present invention.

Namely, as shown in FIG. 11A and FIG. 11B, the small image pickup module according to the tenth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the tenth embodiment of the present invention is characterized in that the lens 15 and the diaphragm 16 are not directly mounted on the lens-barrel body 13 as in the basic structure shown in FIG. 1, but the lens-barrel mounting portion 30, is structured such that another lens-unit can be mounted on the top portion of the lens-barrel body 13, is provided. The small image pickup module has a feature that the flexible substrate 19 for external connection is mounted on the nonmetal substrate 11, and the light-blocking pattern 191, formed by adhesion of a conductive material (etching) or silkscreen printing or the like, is formed on the flexible substrate 19 in order to block light from the direction of the bottom portion of the nonmetal substrate 11.

Further, in the basic structure, the small image pickup module according to the tenth embodiment of the present invention structured as described above has a feature that a package in which a two-dimensional sensor according to a prior art is independently housed can be omitted, and a reduction in cost and an improvement of mounting performance can be attempted while improving the optical performance. Further, the lens-barrel mounting portion 30 is provided at the top portion of the lens-barrel body 13, thereby another lens mirror can be mounted on the top portion of the lens-barrel body 13, and in addition, there are the following features.

Namely, in the two-dimensional sensor according to a prior art, the substrate for mounting a sensor must be a material which is expensive and has light-blocking ability in order to provide the substrate itself with a light-blocking ability. However, the small image pickup module according to the tenth embodiment of the present invention has a feature that even a flexible substrate having no light-blocking ability in particular can be used as is as a material of the nonmetal substrate 11, and it can be inexpensive.

(Eleventh Embodiment)

FIG. 12 is a cross-sectional view showing a schematic structure of a small image pickup module according to an eleventh embodiment of the present invention.

Namely, as shown in FIG. 12, the small image pickup module according to the eleventh embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14 which is mounted on the lens-barrel body 13, as shown in FIG. 1, and a lens-barrel mounting portion 30 structured such that another lens-unit can be mounted on the top portion of the lens-barrel body 13.

In the basic structure of the small image pickup module structured in this way, the small image pickup module according to the eleventh embodiment of the present invention is characterized in that the lens 15 and the diaphragm 16 are not directly mounted on the lens-barrel body 13 as in the basic structure shown in FIG. 1, but the lens-barrel mounting portion 30, structured such that another lens-unit can be mounted on the top portion of the lens-barrel body 13, is provided. The small image pickup module has a feature that the land-and-through-hole portion 20 for external connection is provided at the nonmetal substrate 11, and electric connection and mechanical holding of the nonmetal substrate 11 and the other substrate 21 are made possible due to the other substrate 21 being soldered or engaged by the metal pin 23 at the land-and-through-hole portion 20.

Further, in the basic structure, the small image pickup module according to the eleventh embodiment of the present invention structured as described above is characterized in that a package in which a two-dimensional sensor according to the prior art is independently housed can be omitted, and a reduction in cost and an improvement of mounting performance can be attempted while improving the optical performance. Further, the lens-barrel mounting portion 30 is provided at the top portion of the lens-barrel body 13, thereby another lens-unit can be mounted on the top portion of the lens-barrel body 13, and in addition, there are the following features.

Namely, in the two-dimensional sensor in accordance with the prior art, as means for transmitting signals from the substrate for mounting a sensor to another substrate, connecting by cables, connectors, and the flexible substrate, or the like, is carried out via a third transmitting material with respect to another substrate. Therefore, this is a hindrance to prevention of noise generation and a reduction in costs. However, in the small image pickup module according to the fifth embodiment of the present invention, because the nonmetal substrate 11 and the other substrate 21 are directly connect to each other at the through-hole portion 20, it is possible to reduce size, reduce costs, and prevent noise generation.

(Twelfth Embodiment)

FIG. 13 is a cross-sectional view showing a schematic structure of a small image pickup module according to a twelfth embodiment of the present invention.

Namely, as shown in FIG. 13, the small image pickup module according to the twelfth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, in the small image pickup module according to the twelfth embodiment of the present invention, there is provided at the nonmetal substrate 11 a through-hole portion 24, for electrically connecting between the wiring patterns requiring electric connection among the wiring patterns wired at both surfaces of the nonmetal substrate 11 which exist at a region of the nonmetal substrate 11 at least covered by the lens-barrel body 13.

Further, it is characterized in that the through-hole 24 is filled with a solder 22, thereby capable of being light-blocked.

In this case, the nonmetal substrate 11 is a four-layered substrate in which a power supply layer 25 and a ground layer 26 are provided at intermediate layers.

Further, in this embodiment, there is provided at the nonmetal substrate 11 the land-and-through-hole portion 20, for electrically connecting between the wiring patterns requiring electric connection among the wiring patterns or the other substrates wired at both surfaces of the nonmetal substrate 11 which exist at a region of the nonmetal substrate 11 at least covered by the lens-barrel body 13. The other substrate 21 is connected by soldering or the metal pin 23 at the land-and-through-hole portion 20. Thus, it is possible to electrically connect and mechanically hold the nonmetal substrate 11 and the other substrate 21.

In this case, in the same way as the nonmetal substrate 11, the other substrate 21 is a four-layered substrate, and a power source layer 27 and a ground layer 28 are provided at the intermediate layers.

Further, in the basic structure, the small image pickup module according to the twelfth embodiment of the present invention structured as described above is characterized in that a package in which a two-dimensional sensor according to the prior art is independently housed can be omitted, and a reduction in cost and an improvement of mounting performance can be attempted while improving the optical performance. In addition, there are the following features.

Namely, there is provided at the nonmetal substrate 11 the through-hole portion 24, for electrically connecting between the wiring patterns requiring electric connection among the wiring patterns wired at both surfaces of the nonmetal substrate 11 which exist at a region of the nonmetal substrate 11 at least covered by the lens-barrel body 13. Since the through hole 24 is light-shielded by being filled with the solder 22, it is possible to block transmitted light by the through hole portion 24 which is harmful light.

Note that, in this way, the structure, in which there is provided at the nonmetal substrate 11 the through-hole portion 24, for electrically connecting between the wiring patterns requiring electric connection among the wiring patterns wired at both surfaces of the nonmetal substrate 11 which exist at a region of the nonmetal substrate 11 at least covered by the lens-barrel body 13, and the through-hole 24 is filled with the solder 22, thereby transmitted light by the through-hole portion 24 which is harmful light is blocked, can be applied to the first to eleventh embodiments.

Further, in the basic structure, the small image pickup module according to the eleventh embodiment of the present invention structured as described above is characterized in that a package in which a two-dimensional sensor according to the prior art is independently housed can be omitted, and a reduction in cost and an improvement of mounting performance can be attempted while improving the optical performance. In addition, there are the following features. However, in the small image pickup module according to the twelfth embodiment of the present invention, the nonmetal substrate 11 for mounting a sensor and the other substrate 21 are directly connected to each other at the through-hole portion 20. Therefore, it is possible to reduce size, reduce costs, and prevent generation of noise.

Further, in accordance with the present invention recited in claim 1 described later, a package in which a two-dimensional sensor according to the prior art is independently housed can be omitted, and a reduction in cost and improvement of mounting performance can be attempted while improving the optical performance. In addition, the potting materials 171, 172 to be used for Chip-On-Board (COB) mounting are used as the adhesive adhering the lens-barrel body 13 to the nonmetal substrate 11, therefore there is no problem such as the generation of rust or the like with respect to the sensor at the interior. Thus, it is possible to contribute to an improvement in durability and assembly working performance.

Further, in accordance with the present invention recited in claim 5 described later, a package in which a two-dimensional sensor according to the prior art is independently housed can be omitted, and a reduction in cost and improvement of mounting performance can be attempted while improving the optical performance. In addition, as a mounting structure which mounts the lens-barrel body 13 on the nonmetal substrate 11, projections 121, 122 for positioning are provided at the bottom portion of the lens-barrel body 12 and fitting holes 111, 112, in which the projections 121, 122 for positioning provided at the bottom portion of the lens-barrel body are fitted, are provided at opposing positions on the nonmetal substrate 11. Therefore, the nonmetal substrate 11 may be plate-shaped as is, thereby it is extremely inexpensive and assembly also is easy.

According to the present invention recited in claim 2 described later, it is possible to combine the functional effects achieved by the inventions of claims 1 and 5 described later as described above.

Further, in accordance with the present invention recited in claim 6 described later, a package in which a two-dimensional sensor according to a prior art is independently housed can be omitted, and a reduction in cost and improvement of mounting performance can be attempted while improving the optical performance. In addition, the bare chips 18 of various ICs are mounted on the outer side or the like of the lens-barrel body 13 on the nonmetal substrate 11. Therefore, all of the deficiencies such as hindering prevention of noise generation and a reduction in costs or the like can be solved.

According to the present invention recited in claim 3 described later, it is possible to combine the functional effects achieved by the inventions of claims 1 and 6 described later as described above.

According to the present invention recited in claim 4 described later, it is possible to combine the functional effects achieved by the inventions of claims 1, 5 and 6 described later as described above.

Further, in accordance with the present invention recited in claim 7 described later, a package in which a two-dimensional sensor according to the prior art is independently housed can be omitted, and a reduction in cost and improvement of mounting performance can be attempted while improving the optical performance. In addition, the flexible substrate 19 for external connection is mounted on the nonmetal substrate 11, and the light-blocking pattern 191 which blocks the light from the direction of the bottom portion of the nonmetal substrate 11, is formed on the flexible substrate 19. Thus, as the material of the substrate 11, even a flexible substrate which does not have a light-blocking ability in particular can be used as is, and it can be inexpensive.

According to the present invention recited in claim 8 described later, it is possible to combine the functional effects achieved by the inventions of claims 1 and 7 described later as described above.

According to the present invention recited in claim 9 described later, it is possible to combine the functional effects achieved by the inventions of claims 5 and 7 described later as described above.

According to the present invention recited in claim 10 described later, it is possible to combine the functional effects achieved by the inventions of claims 6 and 7 described later as described above.

According to the present invention recited in claim 11 described later, it is possible to combine the functional effects achieved by the inventions of claims 1, 5 and 7 described later as described above.

According to the present invention recited in claim 12 described later, it is possible to combine the functional effects achieved by the inventions of claims 1, 6 and 7 described later as described above.

According to the present invention recited in claim 13 described later, it is possible to combine the functional effects achieved by the inventions of claims 5, 6 and 7 described later as described above.

Further, in accordance with the present invention recited in claim 14 described later, a package in which a two-dimensional sensor according to the prior art is independently housed can be omitted, and a reduction in cost and improvement of mounting performance can be attempted while improving the optical performance. In addition, the land-and-through-hole portion 20 for external connection is provided at the nonmetal substrate 11, and the other substrate 21 is engaged at the land-and-through-hole portion 20. Thus, the nonmetal substrate 11 for mounting a sensor and the other substrate 21 are directly connected to each other at the through-hole portion 20, thereby it is possible to reduce size, reduce costs, and prevent noise generation.

According to the present invention recited in claim 15 described later, it is possible to combine the functional effects achieved by the inventions of claims 1 and 14 described later as described above.

According to the present invention recited in claim 16 described later, it is possible to combine the functional effects achieved by the inventions of claims 5 and 14 described later as described above.

According to the present invention recited in claim 17 described later, it is possible to combine the functional effects achieved by the inventions of claims 1, 5 and 14 described later as described above.

According to the present invention recited in claim 18 described later, it is possible to combine the functional effects achieved by the inventions of claims 6 and 14 described later as described above.

According to the present invention recited in claim 19 described later, it is possible to combine the functional effects achieved by the inventions of claims 1, 6 and 14 described later as described above.

According to the present invention recited in claim 20 described later, it is possible to combine the functional effects achieved by the inventions of claims 5, 6 and 14 described later as described above.

According to the present invention recited in claim 21 described later, it is possible to combine the functional effects achieved by the inventions of claims 7 and 14 described later as described above.

According to the present invention recited in claim 22 described later, it is possible to combine the functional effects achieved by the inventions of claims 1, 7 and 14 described later as described above.

According to the present invention recited in claim 23 described later, it is possible to combine the functional effects achieved by the inventions of claims 5, 7 and 14 described later as described above.

According to the present invention recited in claim 24 described later, it is possible to combine the functional effects achieved by the inventions of claims 6, 7 and 14 described later as described above.

Further, in accordance with the present invention recited in claim 25 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13.

Further, in accordance with the present invention recited in claim 26 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, the potting materials 171, 172 to be used for COB (Chip-On-Board) mounting are used as an adhesive adhering the lens-barrel body 13 to the nonmetal substrate 11, thereby there is no problem such as the generation of rust or the like with respect to the sensor at the interior, and it is possible to contribute to an improvement in durability and assembly working performance.

According to the present invention recited in claim 27 described later, it is possible to combine the functional effects achieved by the inventions of claims 1, 5 and 25 described later as described above.

According to the present invention recited in claim 28 described later, it is possible to combine the functional effects achieved by the inventions of claims 1, 6 and 25 described later as described above.

According to the present invention recited in claim 29 described later, it is possible to combine the functional effects achieved by the inventions of claims 1, 7 and 25 described later as described above.

According to the present invention recited in claim 30 described later, it is possible to combine the functional effects achieved by the inventions of claims 1, 14 and 25 described later as described above.

According to the present invention recited in claim 31 described later, it is possible to combine the functional effects achieved by the inventions of claims 1, 5, 6 and 25 described later as described above.

Further, in accordance with the present invention recited in claim 32 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, as the attaching structure for attaching the lens-barrel body 13 on the nonmetal substrate 11, the projections 121, 122 for positioning are provided at the bottom portion of the lens-barrel body 13 and the fitting holes 111, 112, in which the projections 121, 122 for positioning provided at the bottom portion of the lens-barrel body 13 are fitted, are provided at opposing positions on the nonmetal substrate 11. Since it suffices for the nonmetal substrate 11 to have a planar configuration as is, it is possible to be extremely inexpensive and to be easily assembled.

According to the present invention recited in claim 33 described later, it is possible to combine the functional effects achieved by the inventions of claims 5, 7 and 25 described later as described above.

According to the present invention recited in claim 34 described later, it is possible to combine the functional effects achieved by the inventions of claims 5, 14 and 25 described later as described above.

Further, in accordance with the present invention recited in claim 35 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, the bare chips 18 of the respective ICs are mounted on the outside portion or the like of the lens-barrel body 13 on the nonmetal substrate 11, therefore it is possible to solve all of the deficiencies such as hindering prevention of noise generation and a reduction in costs or the like.

According to the present invention recited in claim 36 described later, it is possible to combine the functional effects achieved by the inventions of claims 6, 7 and 25 described later as described above.

According to the present invention recited in claim 37 described later, it is possible to combine the functional effects achieved by the inventions of claims 6, 14 and 25 described later as described above.

Further, in accordance with the present invention recited in claim 38 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens mirror can be mounted on the top portion of the lens-barrel body 13. Even a flexible substrate having no light-blocking ability in particular can be used as is as a material of the nonmetal substrate 11, and it can be inexpensive.

According to the present invention recited in claim 39 described later, it is possible to combine the functional effects achieved by the inventions of claims 7, 14 and 25 described later as described above.

Further, in accordance with the present invention recited in claim 40 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, the nonmetal substrate 11 and the other substrate 21 are directly connected to each other at the through-hole portion 20, thereby it is possible to reduce size, reduce costs, and prevent noise generation.

Further, in accordance with the present invention recited in claim 42 described later, a package in which a two-dimensional sensor according to the prior art is independently housed can be omitted, and a reduction in cost and improvement of mounting performance can be attempted while improving the optical performance. In addition, the lens-barrel mounting portion 30 is provided at the top portion of the lens-barrel body 13, thereby another lens-unit can be mounted on the top portion of the lens-barrel body 13. Further, there is provided at the nonmetal substrate 11 the through-hole portion 24, for electrically connecting between the wiring patterns requiring electric connection among the wiring patterns wired at both surfaces of the nonmetal substrate 11 which exist at a region of the nonmetal substrate 11 at least covered by the lens-barrel body 13, and the through hole 24 is light-shielded by being filled with the solder 22. Therefore, it is possible to block transmitted light by the through hole portion 24 which is harmful light.

Note that, as described above, in the prior art in accordance with Japanese Patent No. 2559986, it is mounted on the substrate by utilizing a spring effect using the side wall of an enclosure. Therefore, there is the problem that joggling based on the creep phenomenon over time occurs. However, in the present invention recited in claim 1 described later, a potting material to be used for Chip-On-Board (COB) mounting is used as the adhesive adhering the lens-barrel body to the substrate in order to basically prevent load from being applied to the side wall. Therefore, it is possible to overcome the problem of joggling based on the creep phenomenon over time occurring.

Further, as described above, in the prior art in accordance with Jpn. Pat. Appln. KOKAI Publication No. 9-232548, because all are structured from a single member, there are the problems that the shape and the structure are complicated, the productivity is poor, and the manufacturing costs increase. However, in the present invention recited in claims 1 to 12 described later, all are not basically structured from a single member. Accordingly, the shapes and the structures of the respective members are simple, the productivity is good, and a reduction in manufacturing costs can be attempted.

Further, as described above, in the prior art in accordance with Jpn. Pat. Appln. KOKOKU Publication No. 8-28435, since there is a structure in which a metal can and a lens molten glass are adhered, there is the need to consider the wetting characteristic of the molten glass. However, in the present invention recited in claims 1 to 12 described later, by basically using a lens which has already been molded, there is no need to consider the wetting characteristic of a molten glass.

Further, as described above, in the prior art in accordance with Jpn. Pat. Appln. KOKAI Publication No. 10-41492, since it is a structure in which a lens cap and a pedestal are positioned and fixed by a guiding pin, the lens cap and the guiding pin are necessary. Therefore, there are the problems that the structure is complicated, the productivity is poor, and the manufacturing costs increase. However, in the present invention recited in claims 1 to 12 described later, the lens cap is basically not necessary, and the guiding pin is not always necessary.

Accordingly, as described above, according to the present invention, in a structure in which a semiconductor device chip for image pickup, including a two-dimensional C-MOS image sensor or the like, is mounted on a substrate made from a nonmetal including a ceramic or the like, and a lens-barrel is mounted so as to cover the semiconductor device chip for image pickup, the mounting structure is variously improved. Accordingly, it is possible to provide a small image pickup module in which the assembly work is easy and a reduction in costs is possible.

What is claimed is:

1. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter, a lens, and a diaphragm which are respectively mounted on the lens-barrel body,
wherein a potting material to be used for COB (Chip On Board) mounting is used as an adhesive adhering the lens-barrel body to the substrate.

2. A small image pickup module according to claim 1, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

3. A small image pickup module according to claim 1, wherein bare chips of various ICs are mounted on the substrate.

4. A small image pickup module according to claim 2, wherein bare chips of various ICs are mounted on the substrate.

5. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter, a lens, and a diaphragm which are respectively mounted on the lens-barrel body,
wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

6. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter, a lens, and a diaphragm which are respectively mounted on the lens-barrel body,
wherein bare chips of various ICs are mounted on the substrate.

7. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter, a lens, and a diaphragm which are respectively mounted on the lens-barrel body,
wherein a flexible substrate for external connection is mounted on the substrate, and a light-blocking pattern which blocks light from a direction of a bottom portion of the substrate is formed on the flexible substrate.

8. A small image pickup module according to claim 7, wherein a potting material to be used for COB (Chip-On-Board) mounting is used as an adhesive adhering the lens-barrel body to the substrate.

9. A small image pickup module according to claim 7, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

10. A small image pickup module according to claim 7, wherein bare chips of various ICs are mounted on the substrate.

11. A small image pickup module according to claim 8, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

12. A small image pickup module according to claim 8, wherein bare chips of various ICs are mounted on the substrate.

13. A small image pickup module according to claim 9, wherein bare chips of various ICs are mounted on the substrate.

14. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter, a lens, and a diaphragm which are respectively mounted on the lens-barrel body,
wherein a land-and-through-hole portion for external connection is provided at the substrate, and electric connection and mechanical holding with another substrate are made possible due to the other substrate being engaged at the land-and-through-hole portion.

15. A small image pickup module according to claim 14, wherein a potting material to be used for COB (Chip-On-Board) mounting is used as an adhesive adhering the lens-barrel body to the substrate.

16. A small image pickup module according to claim 14, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

17. A small image pickup module according to claim 15, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

18. A small image pickup module according to claim 14, wherein bare chips of various ICs are mounted on the substrate.

19. A small image pickup module according to claim 15, wherein bare chips of various ICs are mounted on the substrate.

20. A small image pickup module according to claim 16, wherein bare chips of various ICs are mounted on the substrate.

21. A small image pickup module according to claim 14, wherein a flexible substrate for external connection is mounted on the substrate, and a light-blocking pattern which blocks light from a direction of a bottom portion of the substrate is formed on the flexible substrate.

22. A small image pickup module according to claim 15, wherein a flexible substrate for external connection is mounted on the substrate, and a light-blocking pattern which blocks light from a direction of a bottom portion of the substrate is formed on the flexible substrate.

23. A small image pickup module according to claim 16, wherein a flexible substrate for external connection is mounted on the substrate, and a light-blocking pattern which blocks light from a direction of a bottom portion of the substrate is formed on the flexible substrate.

24. A small image pickup module according to claim 18, wherein a flexible substrate for external connection is mounted on the substrate, and a light-blocking pattern which blocks light from a direction of a bottom portion of the substrate is formed on the flexible substrate.

25. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached as a reference to the substrate so as to cover the semiconductor device chip for image pickup; and
an infrared light blocking filter which is mounted on the lens-barrel body,
wherein the lens-barrel body has a structure such that another lens-unit can be mounted.

26. A small image pickup module according to claim 25, wherein a potting material to be used for COB (Chip-On-Board) mounting is used as an adhesive adhering the lens-barrel body to the substrate.

27. A small image pickup module according to claim 26, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

28. A small image pickup module according to claim 26, wherein bare chips of various ICs are mounted on the substrate.

29. A small image pickup module according to claim 26, wherein a flexible substrate for external connection is mounted on the substrate, and a light-blocking pattern which blocks light from a direction of a bottom portion of the substrate is formed on the flexible substrate.

30. A small image pickup module according to claim 26, wherein a land-and-through-hole portion for external connection is provided at the substrate, and electric connection and mechanical holding with another substrate are made possible due to the other substrate being engaged at the land-and-through-hole portion.

31. A small image pickup module according to claim 27, wherein bare chips of various ICs are mounted on the substrate.

32. A small image pickup module according to claim 25, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

33. A small image pickup module according to claim 32, wherein a flexible substrate for external connection is mounted on the substrate, and a light-blocking pattern which blocks light from a direction of a bottom portion of the substrate is formed on the flexible substrate.

34. A small image pickup module according to claim 32, wherein a land-and-through-hole portion for external connection is provided at the substrate, and electric connection and mechanical holding with another substrate are made possible due to the other substrate being engaged at the land-and-through-hole portion.

35. A small image pickup module according to claim 25, wherein bare chips of various ICs are mounted on the substrate.

36. A small image pickup module according to claim 35, wherein a flexible substrate for external connection is mounted on the substrate, and a light-blocking pattern which blocks light from a direction of a bottom portion of the substrate is formed on the flexible substrate.

37. A small image pickup module according to claim 35, wherein a land-and-through-hole portion for external connection is provided at the substrate, and electric connection and mechanical holding with another substrate are made possible due to the other substrate being engaged at the land-and-through-hole portion.

38. A small image pickup module according to claim 25, wherein a flexible substrate for external connection is mounted on the substrate, and a light-blocking pattern which blocks light from a direction of a bottom portion of the substrate is formed on the flexible substrate.

39. A small image pickup module according to claim 38, wherein a land-and-through-hole portion for external connection is provided at the substrate, and electric connection and mechanical holding with another substrate are made possible due to the other substrate being engaged at the land-and-through-hole portion.

40. A small image pickup module according to claim 25, wherein a land-and-through-hole portion for external connection is provided at the substrate, and electric connection and mechanical holding with another substrate are made possible due to the other substrate being engaged at the land-and-through-hole portion.

41. A small image pickup module according to any one of claims 1 to 40, wherein a through-hole portion is provided in order to electrically connect between the wiring patterns of a plurality of layers or surfaces of the substrate which exist at a region of the substrate covered at least by the lens-barrel body, and the through-hole portion is light-blocked by being filled with a solder.
